(19) United States
(12) Patent Application Publication
(10) Pub. No.: US 2005/0226982 A1
(43) Pub. Date: Oct. 13, 2005

(54) Authentic refried beans rapidly produced from dehydrated starting material

(75) Inventors: Mark M. Sterner, Roseburg, OR (US); Mark H. Sterner, Riverside, CA (US); Janelle K. Sterner, Riverside, CA (US)

Correspondence Address: STETINA BRUNDA GARRED & BRUCKER, 75 ENTERPRISE, SUITE 250, ALISO VIEJO, CA, 92656, US

(73) Assignee: Inland Empire Foods

(21) Appl. No.: 11/096,677

(22) Filed: Apr. 1, 2005

Related U.S. Application Data
(60) Provisional application No. 60/561,177, filed on Apr. 8, 2004.
(60) Provisional application No. 60/604,399, filed on Aug. 24, 2004.

(51) Int. Cl. A23L 1/00

(52) U.S. Cl. 426/508

(57) ABSTRACT

Provided is a method for rapid preparation of authentic refried beans from dehydrated starting material such as bean flakes. The method comprises the steps of providing a heated cooking surface, adding dehydrated beans to the heated cooking surface, adding water, stirring the mixture to achieve a bean mixture or slurry until the product begins to pull away from the heated cooking surface and browning begins to occur. The heated cooking surface optionally comprises cooking oil and further optionally comprises ingredients for sauteing thereon. This method enhances and intensifies the flavor of the refried bean product, thus producing a traditional frijoles refritos.

### CROSS-REFERENCE TO RELATED APPLICATIONS

This application claims the benefit of U.S. Provisional Application No. 60/561,177, filed Apr. 8, 2004, and U.S. Provisional Application No. 60/604,399, filed Aug. 24, 2004, the entire contents of both Provisional Applications being incorporated by reference herein.

### STATEMENT RE: FEDERALLY SPONSORED RESEARCH/DEVELOPMENT

(Not Applicable)

### BACKGROUND OF THE INVENTION

The present invention relates generally to food preparation and, more particularly, to an improved method for rapidly preparing authentic refried beans produced from dehydrated starting material.

The Mexican phrase “frijoles refritos” is commonly mistranslated as “refried beans”, i.e. beans twice fried. The true meaning of the phrase is “well fried” or “really fried” beans. Authentic frijoles refritos made from scratch require a lengthy process. The process includes sorting and washing raw beans to remove foreign material before soaking the beans in water overnight after which the beans are simmered for most of the day until soft. When cooked, some beans may be served as whole beans while they are still hot. The remainder of the beans may be held over for frying the next day or they may be fried while still hot. Traditional frijoles refritos are mashed and fried. Importantly, the act of frying facilitates browning which develops the distinctly authentic flavor of true frijoles refritos.

Refried beans are enormously popular as a dish in Mexican style cooking. In both residential (i.e., home) and institutional (i.e., restaurant) applications, Mexican foods have become one of the fastest growing food staples in the food market. Prepared products such as canned refried beans and dehydrated refried beans have helped to popularize them by alleviating the lengthy traditional preparation process. However the Mexican segment of the market, with its cultured and discriminating taste, prefers the traditional refried beans.

Canned “refried beans” were the first ready-to-heat and eat refried beans on the market. Examples of today's offerings of canned refried beans are Goyo™ “PINTO BEANS”, Rosarita™ “TRADITIONAL REFRIED BEANS” (No Fat), Ducal™ “REFRIED BLACK BEANS”, Rosarita™ “GREEN CHILE AND LIME REFRIED BEANS”, Knorr™ “REFRIED BLACK BEANS”, Rosarita™ “BLACK REFRIED BEANS”, Ortega™ “FAT FREE REFRIED BEANS” and Rosarita™ “TRADITIONAL REFRIED BEANS”.

Typical heating directions for canned refried beans include stove top preparation and microwave preparation. The stovetop preparation directions are very simple: “Heat in a saucepan over medium heat until hot”. The microwave preparation directions are slightly more complex: “Heat in a covered microwave-safe dish on high for 4 to 6 minutes, or until hot. Stir once during cooking time.” Notably, canned refried beans are not fried at all. Typical ingredients of canned refried beans include cooked beans, water, lard, salt, chili pepper, distilled vinegar, onion powder, spices, garlic powder and natural flavor. Furthermore, canned refried beans not only lack the traditionally fried product flavor quality but they also have an undesirable canned flavor.

In light of the above described deficiencies associated with refried beans that are provided in cans, various manufactures have, during the past twenty years, began producing dehydrated bean products that, to a certain extent, have overcome some of the problems associated with canned refried beans such as heavy shipping weight as well as the problem of disposing of empty cans. Additional deficiencies associated with canned refried beans, not exclusive to the above-mentioned flavor problems, are resolved.

U.S. Pat. No. 4,871,567 issued to Sterner et al. discloses a method of preparing a reconstitutable refried bean product which contains a quantity of whole beans as well as a quantity of crushed or mashed beans. The method disclosed in the '567 reference includes the steps of inspecting, destoning, cleaning and washing the whole beans. The method further includes the steps of tempering the whole beans for a predetermined period of time after which the whole beans are divided into two sub-quantities, one of which is destined to be crushed or mashed and the other which remains whole, and the steps of cooking, dehydrating, adding secondary ingredients, and packaging, in order to provide an easily reconstitutable refried bean product having both whole and crushed beans.

U.S. Pat. No. 4,735,816 represents a further example of a process for producing dehydrated refried bean products that can be reconstituted upon subsequent hydration. The '816 patent discloses a process for producing dried beans to form an instantly reconstitutable product. The process of the '816 patent discloses the steps of cooking the beans in a manner wherein the skin remains generally intact and wherein the cooked beans are subsequently pressed in order to minimize grittiness and graininess. The pressed beans are of sufficient thickness to allow rapid dehydration and rapid reconstitution or rehydration to provide a reconstituted bean product that has the characteristics similar to those of conventional prepared non-dehydrated beans.

U.S. Pat. No. 5,980,971 discloses a process for producing a dehydrated refried bean product that can be reconstituted upon subsequent hydration. The process disclosed in the '971 reference is directed towards the production of dehydrated bean flakes and whole beans that allegedly have the appearance and texture of canned or conventionally prepared Mexican style refried beans when reconstituted. The process involves the steps of cleaning, sorting and washing. The beans are either milled by dry grinding or wet milling. The bean mixture or slurry is cooked and dried by a continuous method. Another embodiment is the production of dehydrated whole beans. Whole beans are cooked by conventional methods without pre-cooking or soaking after being sorted, cleaned, and washed. After cooking the whole beans, beans which are no longer intact and now are in the form of a slurry are separated from the intact beans. The whole beans are dried in a manner which does not disrupt their intact structure. The cooked bean slurry is dehydrated to form a flake and/or a powder.

An even further example of an attempt by various manufactures to produce dehydrated refried bean product that can be reconstituted upon subsequent hydration includes that which is disclosed by U.S. Pat. No. 5,744,188. The method disclosed in the '188 reference includes the steps of hydrating raw beans by first treating them with an alkaline solution to raise their Ph level as well as raise the moisture content thereof. The '188 reference then includes the steps of neutralizing the raw product with an acidic solution while raising the moisture content. The hydrated bean product is then cooked and dehydrated to produce a product having the taste and appearance of freshly prepared bean product.

An even further attempt at producing dehydrated refried bean product that can be reconstituted upon subsequent hydration is that which is disclosed in U.S. Pat. No. 4,676,990 issued to Huffman et al. The method disclosed in the '990 reference includes the steps of hydrating the beans and cooking such beans to form a mash prior to forming the resultant mixture into shapes suitable for dehydration to a storage-stable moisture content. The dehydrated density ratio and rehydration ratio allow for substantial reconstitution while not requiring agitation thereof.

U.S. Pat. No. 4,407,840 discloses a process for producing dried refried bean powder which is instantly reconstitutable with water to form a product that allegedly has flavor, color and texture that is consistent with conventionally produced refried beans. The process disclosed in the '840 reference includes the steps of immersing raw beans in hot water to hydrate the beans followed by pressure cooking the beans in a suitable pressure cooker. Upon completion of cooking, the beans and water, which are under relatively high pressures and temperatures in the pressure cooker, are discharged from the cooker in an almost instantaneous manner. This instantaneous release of pressure on the cooked beans result in substantial physical degradation of the beans, thereby forming a bean slurry containing finely divided bean mash, whole bean, pieces and bean skin particles. The slurry may then be milled through a screen having a relatively coarse sieve opening, with minimal grinding action, to reduce the whole bean pieces to a relatively small particle size while the bean skin particles are retained. The milled slurry is then dried, such as by applying the slurry to a single or double drum dryer, to a maximum moisture content of about 6%.

A still further prior art attempt at producing dehydrated refried bean product that can be reconstituted upon subsequent hydration is disclosed in U.S. Patent Application No. 2002/136811. The steps disclosed in the '811 reference includes adding organic acid to water in order to condition the beans during hydration. The '811 reference further includes the steps of cooking the conditioned beans in a pressure vessel followed by decompressing the cooked beans in a hydrostatic loop further followed by dehydrating the decompressed beans to form reconstitutable bean product.

U.S. Pat. No. 6,842,457 discloses yet another method of producing a dehydrated food product directed toward conventionally prepared refried beans. The method uses a special conditioning and cooking apparatus which produces a mixture of cooked whole beans and bean pieces which are spread out in a flat sheet and baked. The baked cake is then broken into chunks.

Likewise U.S. Patent Application No. 2003/068417 discloses a method of preparing reconstitutable, dehydrated refried bean product including the steps of using a microwave/convection oven to dry the cooked beans in such a way as to preserve the integrity of the beans and enhance the texture and quality thereof. The process disclosed under the '417 reference is indicated as reducing the amount of time to produce the reconstitutable, dehydrated bean product as well as reducing the tendency for the beans thereof to adopt a “bird mouthing” configuration prevalent in existing methods for producing such bean product.

The above referenced prior art is directed toward eliminating the lengthy and laborious process that is required to make traditional refried beans from scratch at the point of use, and, in the case of these dehydrated products, addressing the various problems associated with canned refried beans such as flavor problems, high cost of shipping and problems associated with disposal of used containers of refried beans. Notably, some of the above referenced prior art processes have enjoyed commercial success. More specifically, dehydrated refried beans made by the processes described in Patent Nos.: U.S. Pat. No. 4,676,990, U.S. Pat. No. 4,735,816 and U.S. Pat. No. 4,871,567 have enjoyed commercial success in that such processes have been employed in the annual production of the multi-millions of pounds of refried beans by such popular restaurants as Taco Bell, Inc.

Nevertheless, there remains a need in the art for a refried bean that incorporates all the benefits of the available dehydrated refried beans, and which additionally has the preferred flavor and texture of frijoles refritos (i.e., “beans really fried”) such as those which are made from scratch in a Mexican home. The failure of all prior art attempts to produce a canned or dehydrated refried bean with true authentic frijoles refritos flavor is due to the failure in the prior art to include a frying step in the process. Without frying, the beans do not brown during preparation and browning enhances and intensifies the flavor of the refried beans. The prior art dehydrated refried beans are only cooked in water and are reconstituted with hot water, by simmering in hot water, by microwave cooking in the presence of water or, in the case of canned refried beans, by simply heating in a sauce pan or in a microwave oven.

### SUMMARY OF THE INVENTION

Provided is a traditional refried bean product starting with cooked and dehydrated bean material. Also provided is a method or process for rapidly preparing authentic refried beans produced from dehydrated starting material. The cooked and dehydrated bean material is fried and browned on a heated cooking surface while being reconstituted with water, simultaneously developing a rich, authentic Mexican refried bean flavor. Advantageously, the process described herein provides a method for producing authentic Mexican refried beans in a significantly reduced amount of time over the lengthy traditional method of preparing refried beans.

It is contemplated that the heated cooking surface such as the frying pan may be coated with cooking oil and it may also contain ingredients for sauteing. For example, such ingredients may include meat, vegetables, spices and various seasonings and materials. Illustrative examples of ingredients that may be added include onions, onion powder, garlic, garlic powder, chilies, chili powder, pepper, salt, chorizo, and bacon as well as any other desirable ingredient. The particular oil that may be used includes oil from animal fat or vegetable oil according to the preference of the preparer.

Regarding the nature of the dehydrated bean product that may be used, it is contemplated that dehydrated beans can be of any variety of commercially available offerings and preferably be in a flake form. The heated cooking surface is preferably a frying pan or a skillet although any cooking surface for frying may be suitable for the above described process. It is contemplated that in certain embodiments, the heated cooking surface may be of the non-stick variety such as Teflon. It is also contemplated that oil may be excluded prior to adding dehydrated bean material and water to the heated cooking surface. In such instance, the water and bean mixture are simmered and browned in the same manner as in the case where oil is added to the heated cooking surface. It is also contemplated that the process may include the use of a spatula or other stirring or mixing device which may be utilized to perform the stirring action in order to mix the water with the dehydrated bean product and oil and other ingredients into the desired consistency.

Importantly, this invention teaches a method of frying a mixture of a dehydrated bean product with water and, when desired, lard or vegetable fat to produce an authentic fried bean flavor as is traditionally known. Moreover, because the above referenced prior art does teach reconstituting the dehydrated refried beans with water and does not teach or mention the act of frying anywhere in the manufacturing process or in the directions for use, that such products of the prior art lack the authentic Mexican fried and browned flavor which is preferred by North and Central American refried bean consumers. Furthermore, the process disclosed herein results in an authentic Mexican refried bean which additionally has the texture and color of refried beans that are prepared from scratch.

The process described herein results in an authentic traditional refried bean product starting with cooked dehydrated starting material. The benefits of using such process include considerable time savings compared to the time required to prepare the refried beans starting from scratch with raw beans. For example, in order to clean, soak and cook raw beans in a home setting requires a span of about 18 hours or more to prepare the beans for frying whereas dehydrated bean material is ready to fry immediately after purchasing.

Advantageously, the process for producing traditional refried beans from dehydrated starting material takes much less time than traditional methods of producing refried beans. It is estimated that the preparation of a desired product may require as little as three minutes depending on the nature of the starting dehydrated product (e.g., whether low density flake beans are used.) Importantly, producing refried beans under the disclosed process results in a superior product with exceptional taste, texture and color. A further advantage of using this invention is that browning can be achieved by using the frying capabilities of the heated cooking surface such as a frying pan. Such browning increases the depth and concentration of flavors throughout the refried bean product thereby improving the overall quality of the refried beans.

In one aspect of the invention, a heated cooking surface, such as a frying pan, is heated, such as on a stove. The heated cooking surface is preferably raised to a relatively high temperature. Fat or oil may optionally be added to the heated cooking surface such as by distributing the oil or fat over the heated cooking surface. Dehydrated bean products may then be added to the heated cooking surface. If oil is added to the heated cooking surface, the oil may cover at least a portion of the heated cooking surface and/or frying pan. Water may then be added to the heated cooking surface. However, it is preferable that the water is not added directly to the heated oil, but is added only after the bean flakes and/or powder have been added to the oil on the heated cooking surface and/or in the frying pan. Notably, in the presence of dehydrated bean products, water does not cause the oil to splatter out of the heated cooking surface or frying pan which increases the safety and overall sanitation of the process.

Regarding the temperature at which the heated cooking surface should be heated prior to introduction of the bean product or prior to frying of the bean product/water/oil combination, it is estimated that the oil and/or the heated cooking surface is preferably at a temperature greater than 250° F. and preferably between 325° F. and 350° F. in the cooking step. Regarding proportions with which the ingredients may be added, in certain embodiments, such as low density flakes from Inland Empire Foods, Inc., the dehydrated bean product and water may be added in equal or roughly equal portions.

In some embodiments, it is contemplated that water in the mixture may evaporate through prolonged stirring and heating such that the bean mixture or slurry achieves a thicker (i.e., less soupy) consistency. It is estimated that in preferred embodiments of the above described process, the method takes between about 2½ minutes to about 4 minutes. However, in situations where refried bean product is derived from a starting material of whole beans, a matrix of bean pieces and whole beans, and baked chunks, the process may consume longer periods of time such as on the order of about 3 to about 40 minutes. In such instances, a higher ratio of water to beans may be required. When using these higher density dehydrated beans, the water ratio required may be three volumes of water to each volume of dehydrated bean product.

In a further aspect of the invention, the refried bean product may be produced according to any of the preceding described methods or processes. It is also noted that any of the preceding embodiments or processes disclosed herein can be combined to produce the end result. In certain preferred embodiments, the product will result in a bean cake not unlike a breakfast pancake. In other embodiments it may be a loose bean paste. In still other embodiments it may be substantially whole beans. However, it is contemplated that the end product may be a combination of the above cake, paste and/or whole bean forms. In this regard, it is contemplated that the end product may be provided in any size, shape or configuration suitable for the application.

### DETAILED DESCRIPTION OF THE INVENTION

Provided is a unique method for producing refried beans from dehydrated starting material such as dehydrated beans flakes. The dehydrated beans may also be provided in bean powder form, in a combination of bean flakes and whole beans, in the form of whole beans only. Furthermore, the dehydrated beans may also be provided in the form of a bean matrix including flat and round shaped beans or in a bean matrix of bean pieces and whole beans. It should be noted that the dehydrated beans may be made from cultivars such as phaseolus vulgaris. In addition, the dehydrated beans may contain a component of animal fat or vegetable oil and/or at least one seasoning. Such seasoning may include salt, onion, garlic, chili pepper and spice, either individually or in various combinations thereof. Other seasonings may be added as well.

Low density or high density bean flakes such as that which is available from Inland Empire Foods of Riverside, Calif. is a preferred starting material. In the process, dehydrated beans are added to a heated cooking surface which is preferably at a temperature above about 250° F. and, more preferably, may be in the range of from about 325° F. to about 350° F.

Oil may optionally be added to a heated cooking surface such that the heated cooking surface is at least partially covered with the oil. Thereafter, dehydrated beans such as in the bean flake form may be added to the heated cooking surface. However, the dehydrated beans may be added to the heated cooking surface with no oil being added thereto. Water may then be added to the dehydrated beans on the heated cooking surface to form a bean mixture or slurry. The bean mixture or slurry is stirred to facilitate rehydration and/or evaporation until the bean mixture achieves the desired browning and consistency.

The dehydrated beans and the water may be added in substantially equal volumetric proportions. It is also contemplated that the volumetric ratio of water to dehydrated refried beans may also be in the range of from about 1:1 to about 3:1. However, it is contemplated that the dehydrated beans and the water may be added in any ratio.

It should be noted that the above described sequence or steps may be varied in any format, e.g., by adding water, then beans, then oil, or by adding oil, then beans, then water, or by adding beans, then water, then oil, etc. As was earlier mentioned, the above steps can be performed without including the oil. Ingredients such as meat, vegetables, seasonings, and spices may be added to the heated cooking surface. Furthermore, such ingredients may be sauteed in oil on the heated cooking surface. It is also contemplated that such ingredients may be removed from the oil prior to adding the dehydrated beans such that the ingredient flavor is imparted to the oil.

As can be seen, the particular order of steps for producing the refried beans is not important. Toward this end, any sequence of steps listed in the claims is not to be interpreted as sequence limiting of the claims unless specifically stated in the claims as such. It is contemplated that the preparation time is generally from about 3 minutes to about 40 minutes. For the case wherein the dehydrated refried beans are in bean flake form, it is contemplated that the preparation time is in the range of from about 3 minutes to about 5 minutes. For the case where the dehydrated beans are in extruded form, the preparation time is contemplated to be in the range of from about 15 minutes to about 40 minutes. For the case where the dehydrated beans are in the form of the bean matrix of bean pieces and whole beans, the preparation time is contemplated to be in the range of from about 5 minutes to about 30 minutes.

In the first embodiment herein, the dehydrated bean starting material has not been previously rehydrated and is placed directly on the heated cooking surface. As was earlier mentioned, oil in the form of vegetable oil, animal fat may optionally be added to the heated cooking surface. Water may then be added to the dehydrated bean such as by pouring over the beans on the heated cooking surface. The resulting bean mixture or slurry may be stirred until the bean material begins to pull away from, and begin to brown on, the heated cooking surface. At this point, the refried beans are ready to serve. This whole process takes approximately three minutes if the dehydrated beans are of the flake type available from Inland Empire Foods of Riverside, Calif. These flakes are produced pursuant to that which is disclosed in letter Patent No. U.S. Pat. No. 4,735,816, the entire contents of which are herein incorporated by reference.

The texture of the end product of the invention is influenced by the form of the starting dehydrated bean material. A smooth bean paste is achieved by using dehydrated bean in bean powder or bean flour as the starting material. The end product may result in a bean cake similar to a breakfast pancake. However, the end product may be a matrix of the bean cake, bean paste and/or whole bean forms and may be result in any size, shape or configuration suitable for the application. A chunky texture may be achieved by using a mixture of dehydrated bean flake and dehydrated whole beans as is disclosed in letter Patent No. U.S. Pat. No. 4,871,567 and available from Inland Empire Foods of Riverside, Calif. The '567 patent is herein incorporated in its entirety by reference. The references cited here above and below are examples only and are not meant to be limiting.

Described below are specific examples that are illustrative of the various processes that may be used in this invention. Such examples are illustrative only and are not intended to be limiting of the broad scope and spirit of the invention.

### EXAMPLE 1

### Preparation Instructions

1. Heat a cooking surface such as a frying pan, griddle or skillet (preferably having a non-sticking surface) on high heat.

2. Add 1 tablespoon of vegetable oil or animal fat.

3. Add 1 heaping cup of Inland Empire Foods dehydrated beans prepared essentially as described in commonly-owned U.S. Pat. No. 4,871,567 and U.S. Pat. No. 4,735,816.

4. Add 1 Cup of water.
5. Using a spatula, stir the bean mixture and fry until desired consistency is achieved while simultaneously browning at least a portion of the bean mixture. If thinner consistency is desired, add more water or fry for a shorter period of time after browning. If thicker consistency is desired, add less water or stir for a longer period of time to evaporate more water after browning.

### EXAMPLE 2

### Preparation Instructions—Without Oil

1. Heat a cooking surface on high heat.
2. Omit step 2 of Example 1.
3. Add 1 heaping cup of Inland Empire Foods dehydrated beans prepared essentially as described in commonly-owned U.S. Pat. No. 4,871,567 and U.S. Pat. No. 4,735,816.
4. Add 1 cup of water to the dehydrated beans on the heated cooking surface to heat the mixture of beans and water.
5. Using a spatula, stir the bean mixture and fry until desired consistency is achieved while simultaneously browning at least a portion of the bean mixture. If thinner consistency is desired, add more water or fry for a shorter period of time after browning. If thicker consistency is desired, add less water or stir for a longer period of time to evaporate more water after browning.

### EXAMPLE 3

### Preparation Instructions—By Weight

1. Heat a cooking surface on high heat.
2. Add 14 grams of vegetable oil or animal fat and heat the oil to approximately 325° to 350° F.
3. Add 127 grams of Inland Empire Foods dehydrated beans.
4. Add 118.5 grams of water to the beans.
5. Using a spatula, stir the bean mixture and fry until desired consistency is achieved while simultaneously browning at least a portion of the bean mixture. If thinner consistency is desired, add more water or fry for a shorter period of time after browning. If thicker consistency is desired, add less water or stir for a longer period of time to evaporate more water after browning.

### EXAMPLE 4

### Preparation Instructions—With Sauteed Ingredients

1. Heat a skillet or frying pan, either nonstick or conventional, on high heat.
2. Add 1 tablespoon of vegetable oil or animal fat. Heat the oil to approximately 325° F. to 350° F.
3. Add desired suggested ingredients for sauteing. Suggested ingredients include, e.g., green onions, garlic or onion.
4. Add 1 cup of Inland Empire Foods Dehydrated beans.
5. Add 1 cup of water.
6. Using a spatula, stir the bean mixture and fry until desired consistency is achieved while simultaneously browning at least a portion of the bean mixture. If thinner consistency is desired, add more water or fry for a shorter period of time after browning. If thicker consistency is desired, add less water or stir for a longer period of time to evaporate more water after browning.
   The following ranges of ingredients may be used in any or all of the above described examples for preparing refried bean from dehydrated starting material (i.e., bean flakes).

### EXAMPLE 5

### Ingredients List—Using Inland Empire Foods Low Density Bean Flakes

1. ⅛ cup vegetable oil or animal fat
2. ¼ cup onions, diced
3. 2 cups bean flakes (94 g)
4. 1¼ cups water

### EXAMPLE 6

### Ingredients List—Using Inland Empire Foods High Density Bean Flakes

1. ⅛ cup vegetable oil or animal fat
2. ¼ cup onions, diced
3. 1 cup bean flakes (80 g)
4. 1 cups water

### EXAMPLE 7

### Ingredients List—Using Basic American Foods Bean Ribbons

1. ⅛ cup vegetable oil or animal fat
2. ¼ cup onions, diced
3. 1 cup bean ribbons (125 g) prepared essentially as described in U.S. Pat. No. 4,676,990.
4. 1½ cups water

It should be noted that in Example 4 describing the preparation instructions using sauteed ingredients, that onions may be first browned in the oil or fat after which the onions may be discarded. The remaining oil, which will now include an onion flavor, may be then used to prepare (i.e., fry) the bean flakes to produce the refried bean product in accordance with preparation styles as used in Mexican Hispanic recipes for refried beans.

In light of the four above-listed examples, it will be appreciated that the parameters described may be adjusted according to suit the particular conditions wherein such process may be used. In addition, such parameters may be adjusted depending on whether and to which extent the relative amounts of material are used in proportion to one another. It should also be noted that the foregoing examples are not limiting and are merely representative of various aspects and embodiments of the present invention.

Importantly, the act of frying facilitates browning which develops the distinctly authentic flavor of true frijoles refritos (i.e., “really fried bean”) that is not achievable using prior art dehydrated refried beans that are only reconstituted with hot water by various means. Browning also increases the depth and concentration of flavors in the bean product thereby improving the overall quality of the refried beans.

Additional modifications and improvements of the present inventions may also be apparent to those of ordinary skill in the art. Thus, the particular combination of steps described herein are intended to represent only certain embodiments of the present invention, and are not intended to serve as limitations of alternative methods of processes within the spirit and scope of the invention.

1. A method of producing refried beans from dehydrated starting material, comprising the steps of:
a. providing a heated cooking surface;
b. adding cooked and dehydrated beans to the heated cooking surface;
c. adding water to the cooked and dehydrated beans on the heated cooking surface; and
d. stirring the water and the cooked and dehydrated beans on the heated cooking surface to facilitate the hydration of the beans and form a bean mixture; and
e. applying further heat to the bean mixture to brown at least a portion thereof.

2. The method of claim 1 wherein the heated cooking surface has a non-sticking surface.

3. The method of claim 1 further comprising the step of at least partially covering the heated cooking surface with oil.

4. The method of claim 3 wherein the oil is animal fat.

5. The method of claim 3 wherein the oil is vegetable oil.

6. The method of claim 1 wherein the cooked and dehydrated beans are in bean powder form.

7. The method of claim 1 wherein the cooked and dehydrated beans are in bean flake form.

8. The method of claim 1 wherein the cooked and dehydrated beans are in the form of bean flakes and whole beans.

9. The method of claim 1 wherein the cooked and dehydrated beans are in the form of whole beans.

10. The method of claim 1 wherein the cooked and dehydrated beans are extruded forms of bean matrix including flat and round shapes.

11. The method of claim 1 wherein the cooked and dehydrated beans are in the form of a bean matrix of bean pieces and whole beans.

12. The method of claim 1 wherein the cooked and dehydrated beans are in the form of beans only.

13. The method of claim 1 wherein the cooked and dehydrated beans are made from cultivars such as phaseolus vulgaris.

14. The method of claim 1 wherein the cooked and dehydrated beans contain at least one of a component of animal fat and vegetable oil.

15. The method of claim 1 wherein the cooked and dehydrated beans contain at least one seasoning.

16. The method of claim 15 wherein the seasonings include at least one of salt, onion, garlic, chili pepper and spice.

17. The method of claim 1 wherein the dehydrated beans and the water are added in substantially equal volumetric proportions.

18. The method of claim 1 wherein the volumetric ratio of water to dehydrated beans is in the range of from about 1:1 to about 3:1.

19. The method of claim 1 wherein step (a) comprises adding ingredients for sautéing to the heated cooking surface.

20. The method of claim 19 wherein the ingredients are sauteed in oil on the heated cooking surface with the ingredients being removed therefrom such that ingredient flavors are imparted to the oil.

21. The method of claim 19 wherein the ingredients are selected from one or more members of the group consisting of meat, vegetables, seasonings, and spices.

22. The method of claim 1 wherein the heated cooking surface is a frying pan.

23. The method of claim 1 wherein the heated cooking surface is a skillet.

24. The method of claim 1 wherein the heated cooking surface is a griddle.

25. The method of claim 1 wherein the heated cooking surface is at a temperature greater than 250° F.

26. The method of claim 1 wherein the heated cooking surface is at a temperature in the range of from about 325° F. to about 350° F.

27. The method of claim 1 wherein the stirring facilitates evaporation of water.

28. The method of claim 1 wherein the stirring facilitates rehydration of the beans.

29. The method of claim 1 wherein the preparation time is from about 3 minutes to about 40 minutes.

30. The method of claim 7 wherein the preparation time using the dehydrated beans in bean flake form is from about 3 minutes to about 5 minutes.

31. The method of claim 10 wherein the preparation time using the dehydrated beans in extruded form is from about 15 minutes to about 40 minutes.

32. The method of claim 11 wherein the preparation time using the dehydrated beans in the form of the bean matrix of bean pieces and whole beans is from about 5 minutes to about 30 minutes.

33. Refried beans produced according to the method of any one of claims 1-31.

34. The refried beans of claim 1 wherein the beans are produced into the form of a cake.

35. The refried beans of claim 1 wherein the beans are produced into the form of a paste.

36. The refried beans of claim 1 wherein the beans are produced into the form of a matrix of bean paste and whole beans.
